(19) United States
(12) Patent Application Publication
(10) Pub. No.: US 2017/0270840 A1
(43) Pub. Date: Sep. 21, 2017

(54) REPLACEABLE VEHICLE INSIGNIA

(71) Applicant: Emblemz.com LLC, Chatsworth, CA (US)

(72) Inventors: Erik Solter, Canoga Park, CA (US); Steven Devan, Northridge, CA (US)

(21) Appl. No.: 15/463,040

(22) Filed: Mar. 20, 2017

Related U.S. Application Data
(60) Provisional application No. 62/310,962, filed on Mar. 21, 2016.

(51) Int. Cl. G09F 21/04; B60R 11/00; B60R 13/04; G09F 7/04; G09F 7/18

(52) U.S. Cl. CPC G09F 21/04; G09F 7/04; G09F 7/18; B60R 13/04; B60R 11/00; G09F 2021/041; G09F 2007/1852; G09F 2007/1865; B60R 2011/0063

(57) ABSTRACT

A vehicle insignia having easily replaceable aesthetic features may be secured relative to a vehicle body panel or other substantially planar surface. The vehicle insignia comprises an insignia base having a planar base surface configured to be secured to the planar surface and an opposite top surface circumscribed by a base frame extending away from the top surface to define an inset portion within the base frame and on the top surface. The vehicle insignia comprises an attachment plate secured within the inset portion, wherein the attachment plate comprises a magnetically active plate, such as a ferrous metal plate. The vehicle insignia further comprises a detachable aesthetic insert comprising a magnet configured to be secured relative to the attachment plate, the aesthetic insert defines an aesthetic surface having graphics thereon that provide a desired look and feel for the vehicle insignia.

### CROSS-REFERENCE TO RELATED APPLICATIONS

This patent application claims priority from U.S. provisional patent application Ser. No. 62/310,962, filed Mar. 21, 2016, which is incorporated herein by reference in its entirety.

### BACKGROUND

Vehicle owners, such as individuals, businesses, and other entities, often desire to modify the appearance of their vehicle to have desired aesthetic features not provided by the vehicle manufacturers. For example, individuals may desire to add logos or symbols representative of their favorite sports team to their vehicle; businesses may desire to add the name or logo of their business to the vehicle; and/or the like. Moreover, individuals may periodically desire to remove or change the aesthetic features added to their vehicle, for example, to support a different sports team.

Accordingly, a need exists for aesthetic features that may be removed, modified, and/or replaced from a vehicle to provide a desired aesthetic feature for vehicle owners.

### BRIEF SUMMARY

Various embodiments are directed to a vehicle insignia that may be secured relative to a vehicle body panel or other planar surface. The vehicle insignia comprises an easily replaceable aesthetic feature that enables a user to quickly and easily change the look and feel of the insignia by replacing the aesthetic features secured therein. For example, a user can quickly change the insignia from advertising their personal business to advertising their favorite sports team by simply replacing the aesthetic feature within the insignia.

In various embodiments, the vehicle insignia comprises an insignia base (e.g., a plastic insignia base) having a planar base surface configured to be secured to a vehicle body panel and an opposite top surface, wherein the top surface is circumscribed by a base frame extending away from the top surface to define an inset portion within the base frame; an attachment plate secured within the inset portion of the top surface, wherein the attachment plate comprises a ferrous metal plate; and a detachable aesthetic insert comprising a magnet, wherein the detachable aesthetic insert is magnetically secured to the attachment plate. The base surface of the insignia base may comprise a fastener, such as an adhesive sheet, configured to secure the insignia base to the vehicle body panel. Accordingly, the aesthetic insert may be quickly and easily replaced while the insignia base remains secured relative to the vehicle body panel.

### BRIEF DESCRIPTION OF THE SEVERAL VIEWS OF THE DRAWINGS

Reference will now be made to the accompanying drawings, which are not necessarily drawn to scale, and wherein:

FIG. 1 shows various components of a replaceable vehicle insignia in a disassembled configuration according to one embodiment;

FIG. 2 shows various components of a replaceable vehicle insignia in an assembled configuration according to one embodiment;

FIG. 3 shows an insignia base according to one embodiment; and

FIG. 4 shows a cross-sectional view along lines A-A of the insignia base illustrated in FIG. 3.

### DETAILED DESCRIPTION

The present invention will now be described more fully hereinafter with reference to the accompanying drawings, in which some, but not all embodiments of the invention are shown. Indeed, the invention may be embodied in many different forms and should not be construed as limited to the embodiments set forth herein. Rather, these embodiments are provided so that this disclosure will satisfy applicable legal requirements. Like numbers refer to like elements throughout.

Various embodiments are directed to a vehicle insignia having an interchangeable aesthetic insert that may be secured relative to a base. The base may be secured relative to a support surface, such as a vehicle body panel (e.g., a trunk lid, a tailgate, a hood, and/or the like). In various embodiments, the base may be secured to the support surface via a non-removable fastener (e.g., glue, attachment pins, double-sided tape, and/or the like). The aesthetic insert may be secured relative to base via a detachable fastener (e.g., a magnet) such that the aesthetic insert may be quickly and easily interchanged with other aesthetic inserts.

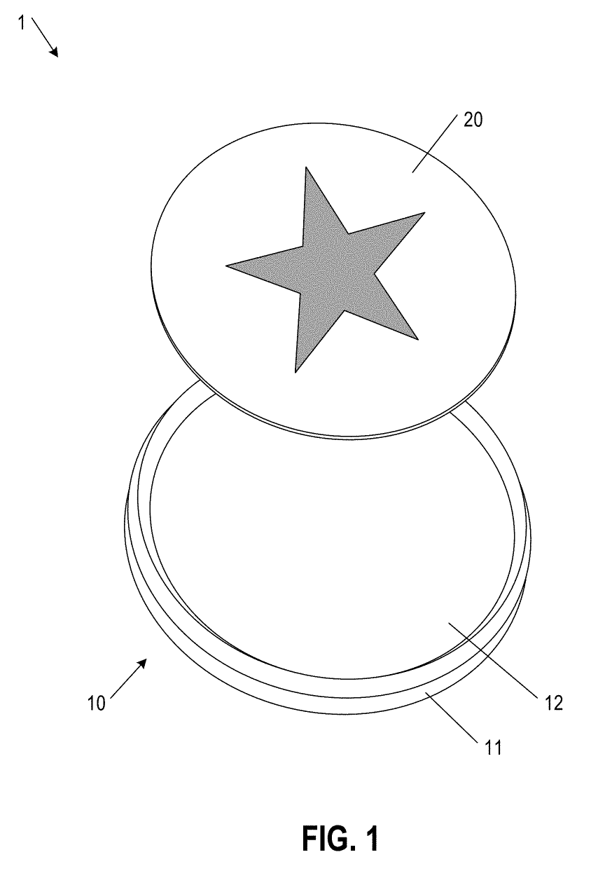

FIG. 1 illustrates a vehicle insignia 1 in a disassembled configuration according to various embodiments. As shown in FIG. 1, the vehicle insignia 1 comprises an insignia base 10 and an aesthetic insert 20. In the illustrated embodiment of FIG. 1, the insignia base 10 defines a planar base surface (visible in the cross-sectional view of FIG. 4) and an opposite top surface. The top surface comprises a base frame 11 circumscribing the top surface and defining an inset portion (visible in FIG. 4) within the base frame 11. In the illustrated embodiment of FIG. 1, the vehicle insignia 1 comprises an attachment plate 12 secured within the inset portion and surrounded by the base frame 11. The attachment plate 12 may be configured to be secured relative to the aesthetic insert 20. With reference briefly to FIG. 4, the insignia base 10 may additionally comprise a support attachment fastener 13 (e.g., an adhesive sheet) secured relative to the planar base surface of the insignia base 10 configured to secure the insignia base 10 relative to a support surface (e.g., a vehicle body panel).

In the illustrated embodiment of FIG. 1, the base frame 11 comprises a non-magnetic material (e.g., a plastic material) and the attachment plate 12 comprises a magnetic material (e.g., a ferrous metal, such as iron). The base frame 11 may comprise a light-weight plastic material in order to limit the overall weight of the base frame 11. Moreover, the base frame 11 may have any desired aesthetic appearance, such as a reflective (e.g., chrome-like) surface, a matte surface, a gloss surface, and/or the like. Moreover, the attachment plate 12 may comprise one or more coatings in order to increase the durability of the attachment plate 12. For example, the attachment plate 12 may comprise a rust-inhibiting coating in order to prevent the attachment plate 12 from rusting.

In various embodiments, the aesthetic insert 20 may be configured to be secured relative to the attachment plate 12. The aesthetic insert 20 may have a size and shape corresponding to the attachment plate 12, such that the aesthetic insert 20 at least substantially covers the entirety of the attachment plate 12 while remaining within and/or aligned with the inset portion of the insignia base 10. Accordingly, in various embodiments, the aesthetic insert 20 may comprise an aesthetic layer (illustrated in FIG. 1 as having a printed, painted, or otherwise indicated star shape) and an attachment layer secured relative to the aesthetic layer. For example, the aesthetic insert 20 may comprise a magnetic layer configured to removably engage the attachment plate 12 such that the aesthetic insert 20 is secured relative to the insignia base 10. The magnetic layer may define a back surface secured relative to the insignia base 10 and an aesthestic surface on which the aesthetic layer is secured (e.g., by directly printing the aesthetic layer onto the magnetic layer, by painting the aesthetic layer onto the magnetic layer, by adhering the aesthetic layer onto the magnetic layer, and/or the like). Although the aesthetic insert 20 is shown as having a two-dimensional aesthetic feature, various embodiments may comprise an aesthetic insert 20 having a three-dimensional aesthetic feature, for example a logo having one or more features protruding from the surface of the aesthetic insert 20.

The aesthetic insert 20 may be configured to be secured to the attachment plate 12 of the insignia base 10 such that the aesthetic insert 20 does not undesirably move relative to the insignia base 10 when the insignia 1 is subject to external forces, such as those associated with movement of a motor vehicle upon which the insignia 1 is secured. Moreover, the aesthetic insert 20 may be configured to remain secured to the attachment plate 12 regardless of orientation of the insignia 1. For example, the aesthetic insert 20 may remain secured to the attachment plate 12 while oriented at least substantially vertically (e.g., while secured to a tailgate of a vehicle), and/or while oriented horizontally such that the aesthetic insert 20 is below the attachment plate 12 (e.g., while secured to an open tailgate of a vehicle).

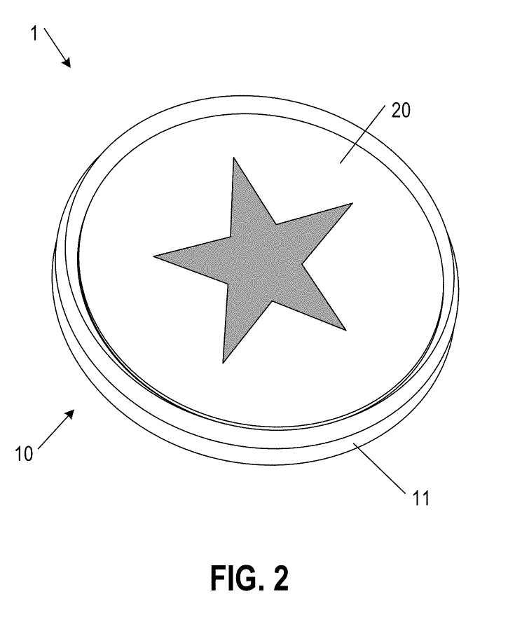

Moreover, the size and shape of the aesthetic insert 20 (e.g., the shape and surface area of the attachment layer) may be at least substantially equal to the size and shape of the attachment plate 12. Accordingly, when the aesthetic insert 20 is secured relative to the insignia base 20, the attachment plate 12 is not visible (as shown in FIG. 2). Thus, the resulting insignia 1 may provide an appearance that the aesthetic insert 20 is a continuous portion of the insignia base 10.

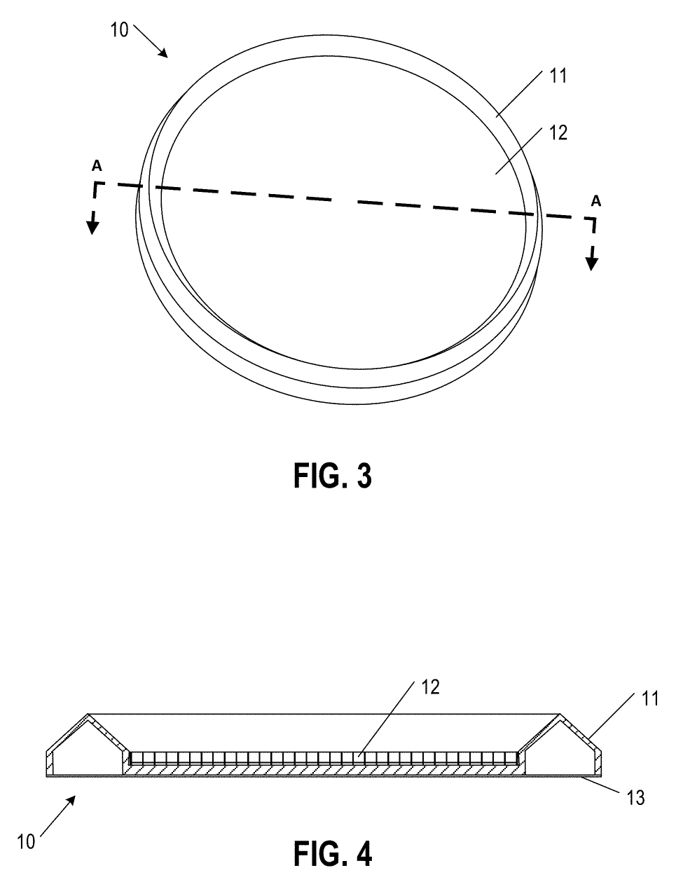

FIG. 3 illustrates the insignia base 10 without a corresponding aesthetic insert 20. As shown in FIG. 3, the insignia base 10 may comprise a base frame 11 having a raised edge surrounding the attachment plate 12. The raised edge surrounding the attachment plate 12 may facilitate placement of the aesthetic insert 20 relative to the attachment plate 12 such that the aesthetic insert 20 at least substantially covers the entirety of the attachment plate 12.

FIG. 4 illustrates a sectional view of the insignia base 10 illustrated in FIG. 3 along section lines A-A. As shown in FIG. 4, the raised edge of the base frame 11 may comprise an at least substantially triangular ridge extending around the entirety of the perimeter of the attachment plate 12 however the raised edge of the base frame 11 may have any of a variety of cross-sectional shapes. The base frame 11 may be hollow, having an open bottom surface aligned with the base surface of the insignia base 10, as shown in FIG. 4. In various embodiments, the hollow interior of the base frame 11 may define a plurality of support ribs spaced (e.g., equally spaced and/or irregularly spaced) along the length of the base frame 11 (measured around the perimeter of the insignia base 10). However, it should be understood that the base frame 11 may be solid in various embodiments. Moreover, as shown in FIG. 4, the base frame 11 may define an inset portion within the raised edges, the inset portion configured to accept the attachment plate 12 therein. As shown in FIG. 4, the attachment plate 12 is positioned and secured (e.g., fastened with glue, double sided tape, and/or the like) within the inset portion of the base frame 11. Moreover, as mentioned previously, the insignia base 10 comprises a support attachment component 13 configured to secure the insignia base 10 relative to a support surface (e.g., a vehicle body panel). As shown in FIG. 4, the support attachment component 13 is secured to a bottom surface of the base frame 11, opposite the attachment plate 12. As mentioned previously, the support attachment component 13 may comprise a non-removable fastener (e.g., glue, attachment pins, double-sided tape, and/or the like).

Moreover, although the insignia 1 and associated components are illustrated as being at least substantially circular, the insignia 1 may have any of a variety of shapes. As a variety of non-limiting examples, the insignia 1 may have an elliptical shape, a rectangular shape, an oval shape, a bow-tie shape, a triangular shape, a shield shape, and/or the like. In various embodiments, the shape of the aesthetic insert 20 may correspond with the shape of the insignia base 10 and corresponding attachment plate 12. For example, a rectangular shaped insignia 1 may have a rectangular shaped attachment plate 12, and a corresponding rectangular shaped aesthetic insert 20.

In various embodiments, the insignia 1 may be installed relative to a support surface by engaging the support attachment component 13 of the insignia base 10 relative to the support surface. For example, in embodiments in which the support attachment component 13 is embodied as double-sided tape, the support attachment component 13 may be pressed against the support surface to thereby secure the insignia base 10 relative to the support surface. The aesthetic insert 20 may then be secured relative to the attachment plate 12 of the insignia base 10. For example, in embodiments in which the aesthetic insert 20 is magnetically secured relative to the attachment plate 12, the aesthetic insert 20 is placed against the attachment plate 12 to secure the aesthetic insert 20 thereto. The aesthetic insert 20 may later be removed and interchanged while the insignia base 10 remains secured to the support surface.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A vehicle insignia configured to be secured relative to a vehicle body panel, the vehicle insignia comprising:
an insignia base having a planar base surface configured to be secured to a vehicle body panel and an opposite top surface, wherein the top surface is circumscribed by a base frame extending away from the top surface to define an inset portion within the base frame;
an attachment plate secured within the inset portion of the top surface, wherein the attachment plate comprises a ferrous metal plate; and
a detachable aesthetic insert comprising a magnet, wherein the detachable aesthetic insert is magnetically secured to the attachment plate.

2. The vehicle insignia of claim 1, wherein the insignia base is formed of a material different than the attachment plate.

3. The vehicle insignia of claim 2, wherein the insignia base is non-magnetic.

4. The vehicle insignia of claim 3, wherein the insignia base comprises a plastic material.

5. The vehicle insignia of claim 1, wherein the attachment plate comprises a protective coating.

6. The vehicle insignia of claim 5, wherein the protective coating is a rust inhibiting coating.

7. The vehicle insignia of claim 1, wherein the attachment plate has a size and a shape corresponding to a size and a shape of the inset portion within the base frame.

8. The vehicle insignia of claim 7, wherein the detachable aesthetic insert has a size and shape corresponding to the size and the shape of the attachment plate.

9. The vehicle insignia of claim 1, wherein the detachable aesthetic insert is at least substantially planar and defines a back surface and an aesthetic surface, wherein the aesthetic surface comprises an aesthetic coating having a graphic thereon.

10. The vehicle insignia of claim 1, wherein the planar base surface of the insignia base comprises a fastener configured to secure the insignia base relative to the vehicle body panel.

11. The vehicle insignia of claim 10, wherein the fastener comprises an adhesive sheet.

12. The vehicle insignia of claim 1, wherein the base frame defines a triangular cross-section extending away from the top surface.

13. The vehicle insignia of claim 1, wherein the base frame is at least substantially hollow.

14. The vehicle insignia of claim 13, wherein the base frame defines an open bottom surface planar with the base surface of the insignia base.

15. The vehicle insignia of claim 14, wherein the planar base surface comprises an adhesive sheet secured across the planar base surface and the open bottom surface of the base frame.
